(19) United States
(12) Patent Application Publication
(10) Pub. No.: US 2008/0240052 A1
(43) Pub. Date: Oct. 2, 2008

(54) CLIENT-BASED INFORMATION SERVICE FOR SEAMLESS VERTICAL HANDOVERS

(76) Inventors: Vivek Gupta, Portland, OR (US); Sangeetha Bangolae, Beaverton, OR (US)

Correspondence Address: CARRIE A. BOONE, P.C., 2450 Louisiana, Suite # 400-711, HOUSTON, TX, 77006, US

(21) Appl. No.: 11/694,982

(22) Filed: Mar. 31, 2007

(51) Int. Cl. H04Q 7/24

(52) U.S. Cl. 370/338

(57) ABSTRACT

A system and method to enable a wireless device having multiple radios to obtain information about wireless networks without each radio having to independently scan for all available networks. The wireless device downloads information from a remote information server, such that the information is later accessible locally. The local information server may be updated independently according to the preferences of the user. The system enables any of the radios to obtain access information without having to perform time- and power-consuming scanning operations, where the access information is sufficient for the radio to make contact with the wireless network, irrespective of whether the radio is tailored to support that network. The system may include wireless neighborhood map(s) of one or more geographic regions. The wireless device is able to ascertain the wireless network landscape of a region without having to actually reside in the geographic region.

### TECHNICAL FIELD

This application relates to wireless communication systems and, more particularly, to network discovery and selection in an environment in which multiple wireless interfaces exist.

### BACKGROUND

The Institute of Electrical and Electronics Engineers (IEEE) has adopted a set of standards for wireless local area networks (LANs), known as 802.11. Wireless products satisfying 802.11a, 802.11b, 802.11g, and 802.11n are currently on the market.

A new generation of mobile and handheld devices has emerged under 802.11n, supporting multiple wireless interfaces or radios. A single mobile device, for example, may have three or four radios, each one supporting a different wireless network, such as wireless wide-area network, or WWAN (cellular), wireless local-area network, or WLAN (802.11a/b/g/n), wireless personal-area network, or WPAN (Bluetooth, UWB, Zigbee), and wireless metropolitan-area network, or WMAN (802.16). The flexibility built into such devices is intended to maximize wireless connectivity and user experiences. Such enhanced capability, however, gives rise to network discovery and selection difficulties when roaming across heterogeneous wireless networks.

For example, a large campus in a school or a business enterprise, such as an airport, may support multiple networks. A mobile device having multiple radios may be connectable to more than one available network at the campus. At any given instant, it may not be possible to determine the best wireless network to which the handover should be made. Further, where each radio of the mobile device performs scanning to ascertain the wireless landscape, the mobile device is likely to experience delays and degradation of battery life, especially if the mobile device is already in a low-power state.

Some radios, such as 802.11 radios, have “site reports” that allow a mobile device to obtain information about all access points in a geographic area. Such site reports are restricted to 802.11 radios, however, and do not supply information about multiple radios/networks. There is no known way for one radio to obtain information about all other radio networks in a given neighborhood.

Thus, there is a continuing need for a mechanism by which a wireless device having multiple radios may obtain information about available networks in a given geographical region.

### BRIEF DESCRIPTION OF THE DRAWINGS

The foregoing aspects and many of the advantages of this disclosure will become more readily appreciated as the same becomes better understood by reference to the following detailed description, when taken in conjunction with the accompanying drawings, wherein like reference numerals refer to like parts throughout the various views, unless otherwise specified.

FIG. 1 is a diagram of a local client-based information system, according to some embodiments;

FIG. 2 is a diagram of the interaction between a wireless device and wireless networks, according to some embodiments;

FIG. 3 is a diagram of the interaction between the wireless device of FIG. 2 and wireless networks using the local client-based information system of FIG. 1, according to some embodiments;

FIG. 4 is a flow diagram showing operations performed by a wireless device in accessing the local client-based information system of FIG. 1, according to some embodiments;

FIG. 5 is a flow diagram showing operations performed by a wireless device in accessing the local client-based information system of FIG. 1, according to some embodiments; and

FIG. 6 is a flow diagram showing operations between a wireless device sharing wireless neighborhood information with a peer node, according to some embodiments.

### DETAILED DESCRIPTION

In accordance with the embodiments described herein, a system and method are disclosed, enabling wireless devices having multiple radios to obtain information about wireless networks within a geographic region without each radio having to independently scan for all available networks. The system includes a local information server, which has been built from a remote information server. The local information server includes information elements that provide access information sufficient for the radio to make contact with the wireless network, irrespective of whether the radio is tailored to support that network. Optionally, the information server database includes a wireless neighborhood map, for a geographic region in which the wireless device is located (or for a different geographic region), enabling the wireless device to ascertain the wireless network landscape of a region without having to perform power-consuming scanning operations.

In the following detailed description, reference is made to the accompanying drawings, which show by way of illustration specific embodiments in which the disclosed concepts may be practiced. However, it is to be understood that other embodiments will become apparent to those of ordinary skill in the art upon reading this disclosure. The following detailed description is, therefore, not to be construed in a limiting sense, as the scope of the description is defined by the claims.

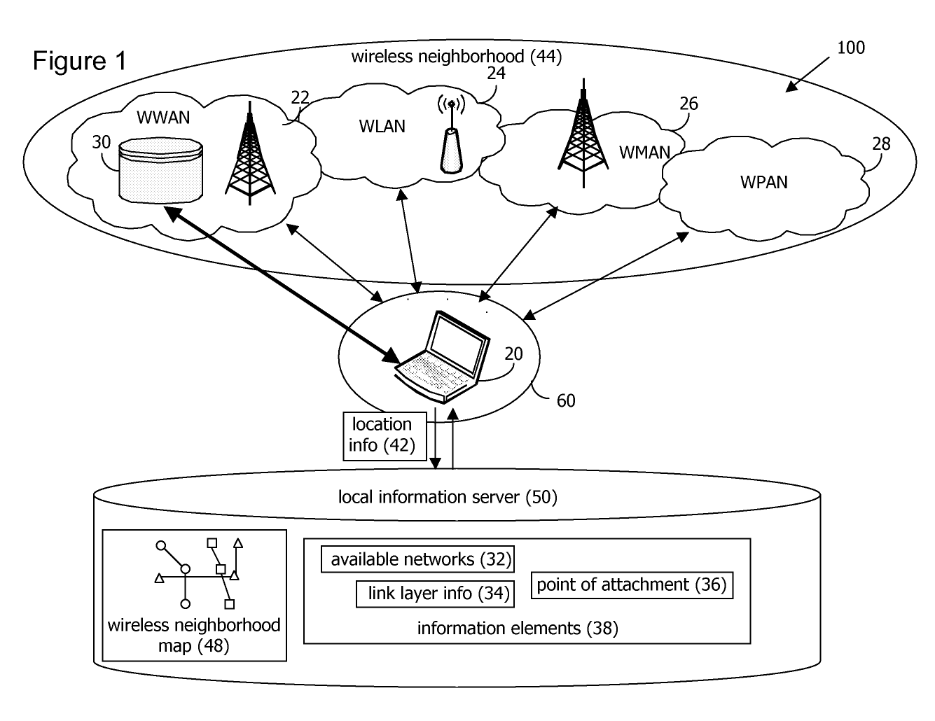

FIG. 1 is a diagram of a client-based information system 100, according to some embodiments. The client-based information system 100 includes an information server database 50. The information server database 50 contains information about the wireless networks in a given geographic area. The wireless networks depicted include a wireless wide-area network, WWAN 22 (for cellular technology), a wireless local-area network, WLAN 24 (for 802.11a, 802.11b, and 802.11g technologies), a wireless metropolitan-area network, WMAN 26 (for 802.16 technologies), and a wireless personal-area network, WPAN 28 (for Bluetooth, UWB, and Zigbee technologies). Together, these wireless networks constitute a wireless neighborhood 44 accessible to a geographic region 60.

A wireless device 20, also known as a client device 20, is part of that geographic region 60. The client device 20 is depicted as a wireless laptop computer. However, the client device 20 may include any wireless communication device equipped with a radio, including but not limited to wireless cellular technology, such as a mobile phone, a wireless personal digital assistant (PDA), a wireless desktop computer, a wireless laptop computer, and so on.

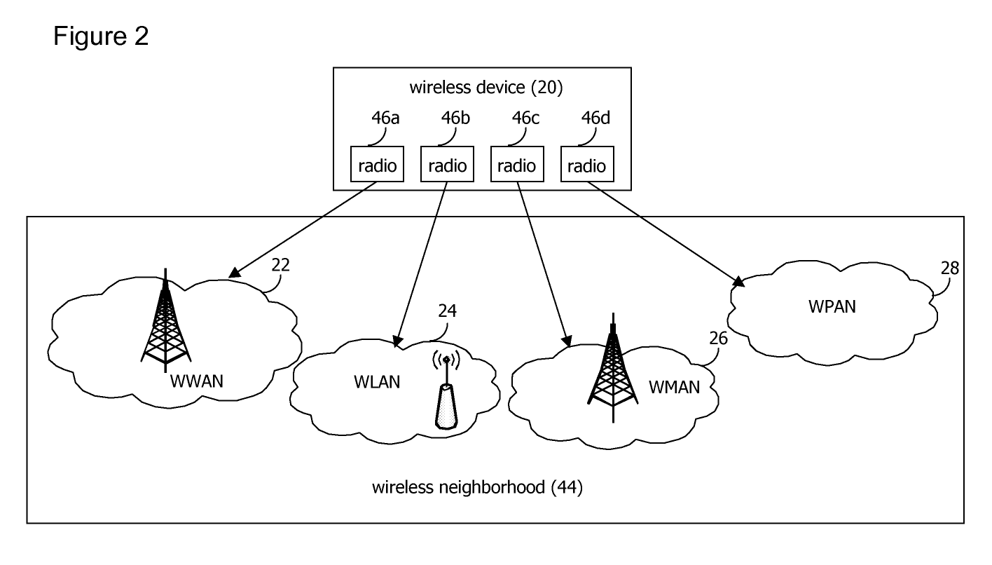

The wireless device 20 is capable of supporting multiple wireless networks, and may thus include multiple radios 46a, 46b, 46c, and 46d (collectively, radios 46), as depicted in FIG. 2. The wireless device 20 includes a radio 46a, to access the WWAN network 22, radio 46b to access the WLAN network 24, radio 46c to access the WMAN network 26, and radio 46d to access the WPAN network 28. For the wireless device 20 to ascertain the wireless landscape or neighborhood 44, each radio performs a scan for its associated wireless network.

One or more wireless networks may include a remote (from the perspective of the wireless device 20) information server. In FIG. 1, only the WWAN network 22 is shown with the remote information server 30. The information server 30 is the connection point for the wireless device 20 when accessing the wireless network. The information server 30 also includes an information database, which includes a variety of information, as described further below, for accessing the wireless network. Typically, to access the information database, the wireless device first connects to the information server 30.

The client-based system 100 eliminates this procedure, which is costly for the wireless device 20, particularly in its power consumption. Instead of each radio independently scanning for an available network, and connecting to the information server 30, as in legacy environments, the client-based system 100 maintains a local copy of the information database, known herein as a local information server 50. A single radio 46 of the wireless device 20 may access the local information server 50 to facilitate access to any network 22, 24, 26, 28 in the client-based information system 100. The information from the remote server 30 is thus available to the wireless device 20, without having to establish a connection to the remote server 30.

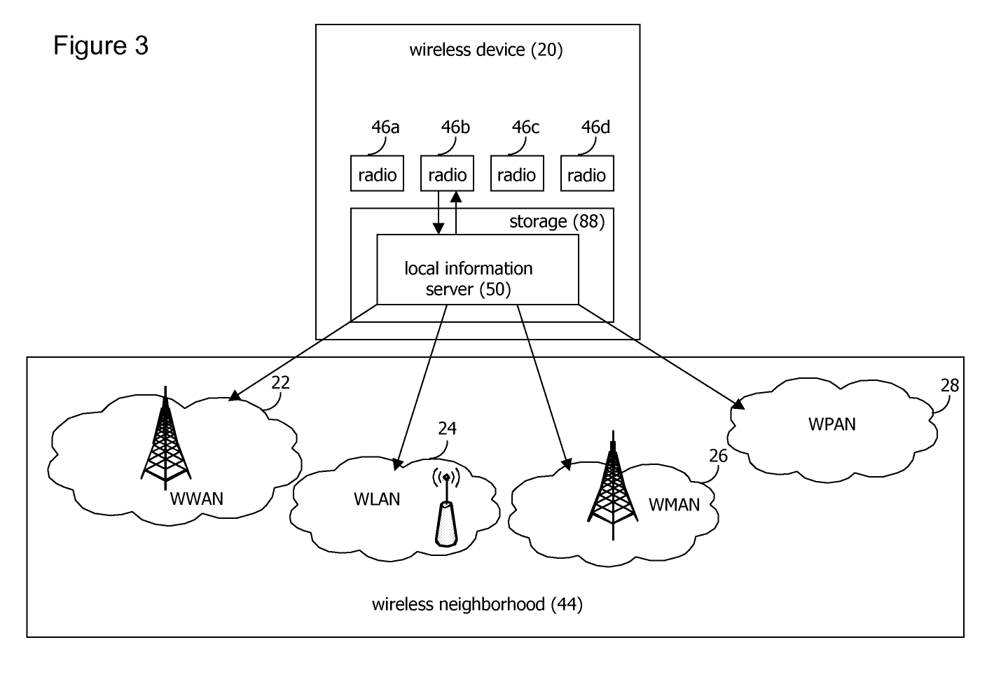

FIG. 3 pictorially represents the change to the wireless device 20 with the availability of the local information server 50, according to some embodiments. The radios 46a-46d are each able to contact the local information server 50 for information about any and all available networks in the wireless neighborhood 44. As shown, only radio 46b is communicating with the local information server 50, yet the wireless device 20 is able to obtain information about any of the available networks. (The other radios 46a, 46c, and 46d may similarly access the local information server 50 for available network information.) Thus, using the local information server 50, a single radio of the wireless device 20 may access any part of the wireless neighborhood 44 without having to scan each available network.

In some embodiments, the information server 30 may be accessible online, such as by connecting to a global network neighborhood, such as the World-Wide Web. The wireless device 20 accesses the information server 30 as any other server may be accessed. Thus, for example, the information server 30 may have a web page or other graphical user interface (GUI) suitable for accessing its database.

The local information server 50 obtains the information elements 38 by downloading them from one or more remote servers 30 controlled by each wireless network. Instead of downloading, there may be some other protocol exchange by which the local information server 50 obtains selected items from the remote server. Although a single remote server 30 is depicted in FIG. 1, each of the wireless networks, the WLAN 24, the WMAN 26, and the WPAN 28, may individually have a remote server as well. The wireless device 20 accesses the remote server 30, such as by logging onto the global network neighborhood, such as the World-Wide Web, and retrieves information elements 38 for storage on the local information server 50. In some embodiments, the wireless device 20 periodically accesses the remote server 30 for each wireless network, so as to keep up-to-date information stored locally on the local information server 50.

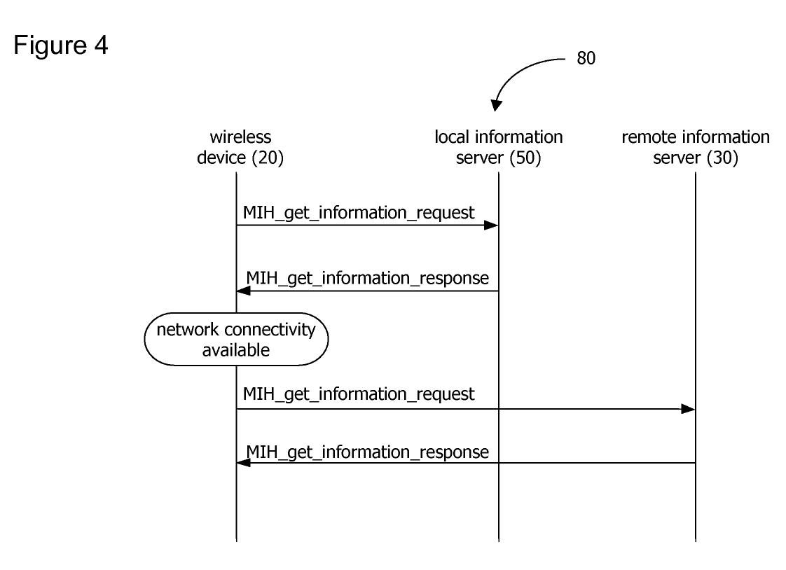

The local information server 50 contains information about all wireless networks in the wireless neighborhood 44 for a given geographical area 60. The local information server 50 includes information elements 38 that enable the wireless device 20 to access one of the available networks. Information elements 38, such as a list of available networks 32, link layer information 34 for each available network, and point of attachment information 36 for each network, which were originally in the database of the remote server 30, are available locally to the wireless device 20. (FIG. 4, described below, illustrates a protocol 80 by which the wireless device 20 may obtain the information elements 38.) Such information elements 38 may be retrieved using any wireless radio. Thus, for example, if the radio 46a is an 802.11 WLAN radio, the radio 46a may retrieve information about 802.16 network (e.g., WMAN 26), a global system for mobile communications, or GSM, network (e.g., WWAN 22), and a wideband code division multiple access, or WCDMA, network (e.g., WLAN 24) in a given geographical region. This eliminates the need to have each radio scan for its associated wireless network.

The client-based information system 100 thus provides a mechanism by which information about all existing wireless networks in an area may be obtained. Previously, the wireless device 20 would power on all radios 46a-46d and sequentially perform a media-sense of each radio to gather information about the available wireless networks 22, 24, 26, 28 in the geographic region 60. With the client-based information system 100, the wireless device 20 may obtain detailed information about preferred networks, avoiding the time- and power-consuming process of sequentially detecting all available networks. The system 100 thus enables the wireless device 20 to reduce the amount of information being processed, speed up the inquiry, or both.

The wireless device 20, operating in the client-based information system 100, may retrieve information about all other radios 46 in the geographical region 60, or neighborhood, of the wireless device. Different wireless devices may use their existing unique hardware identifiers, known as media access control (MAC) identifiers, and transports to access the information server 50, and thus retrieve information about the wireless neighborhood 44. Thus, existing wireless devices may operate without change as part of the client-based information system 100.

The wireless device 20 may retrieve information elements 38 that may be generic or specific to a particular access network. In addition to the information elements 38 shown in FIG. 1, the list of available networks 32, link layer information 34, and point of attachment information 36, the information elements 38 may include link level information, security, operator, carrier policy, list of operators supporting the network, roaming agreements between operators, a neighbor report for the network, properties of a particular point of attachment (access point/base station) for a network, and so on. Essentially, the information elements 38 consist of any information that may facilitate network discovery and selection by the wireless device 20.

Returning to FIG. 1, the local information server 50 further includes a wireless neighborhood map 48, in some embodiments. As with the information elements 38, the wireless neighborhood map 48 may be accessed by connecting to the local information server 50. Once the wireless device 20 is connected to the local information server 50, the wireless neighborhood map 48 may be downloaded to the wireless device 20 for subsequent access. In FIG. 3, the wireless device 20 is shown with storage 88, such that any information retrieved from the remote information server 30 may be saved. The wireless device 20 may include non-volatile storage, such as a fixed disk drive, smart card media, optical media, or volatile storage, such as a random access memory (RAM) card, flash memory, read-only memory (ROM), and the like, for storing the wireless neighborhood map 48 and/or the information elements 38.

The wireless neighborhood map 48 may be a map of a city or town, including wireless access points, and may look similar to a road map. The map 48 may include locations of all WiFi access points (APs) in the geographic region 60, as well as the information elements 38 for those APs, such as security, quality-of-service (QoS), supported data rates, and so on. The information represented on the wireless neighborhood map 48 may be presented in standard type-length-value (TLV) form, or in another form. Service providers may make such wireless neighborhood maps 48 available to their subscribers, based on their coverage of the geographic region 60.

The client-based information system 100 may have maps 48 for a number of different geographic regions, thus enabling the wireless device 20 to download a wireless neighborhood map 48 prospectively, such as in anticipation of travel to a new geographic region 60.

FIG. 4 is a flow diagram showing operations 80 performed by the wireless device 20 in accessing the client-based information system 100 of FIG. 1, according to some embodiments. The wireless device 20 submits a smart query according to a media-independent handover (MIH) protocol. An MIH is an IEEE (Institute of Electrical and Electronics Engineers) term indicating a handover between two radio interfaces. The wireless device 20 submits a get information request (MIH_get_information_request), including the location information 42 about the wireless device 20, to the local information server 50. (Even though stored locally, the wireless device 20 accesses the local information server 50 just as it would access the remote server 30.) The local information server 50 submits a get information response (MIH_get_information_response) back to the wireless device 20. The response includes information elements 38, such as a list of available networks 32, link layer information 34, and point of attachment information 36. At this point, the wireless device 20, armed with the information about the wireless neighborhood 44, is able to connect to one of the networks, without ever having had to connect to the remote server 30.

Accordingly, the wireless device 20 submits a new get information request (MIH_get_information_request), this time to the remote information server 30. Included in this information request is the information elements 38 obtained in the prior request (from the local information server 50), as well as the location information 42 about the wireless device. In FIG. 1, the remote information server 30 is shown as part of the WWAN network 22. Each of the wireless networks 22, 24, 26, and 28 may have associated information servers, referred to herein as “remote” information servers because the information is not locally available to the wireless device 20. The remote server 30 sends a response (MIH_get_information_response) to the wireless device 20, including updated information that may be needed by the device. The MIH_get_information_request submitted by the wireless device 20 may include such parameters as filter location, filter speed, filter direction, filter coverage range, filter preferred operator ID, and so on. Providing more client-based “contextual” information increases chance of doing smart queries and retrieving more relevant information from the perspective of the wireless device 20.

Depending on client mobility, the client device 20 may search for available networks in the geographic region 60, based on the location of the client device 20. In some embodiments, the client device 20 obtains the available network information from the local information server 50, then acts as a server to other wireless devices that are unable to access the information server 50.

The client-based information system 100 thus enables a wireless device 20 to discover information about all wireless networks 44 in a given geographic region 60 and also access the information from the local information server 50. The system 100 has several advantages over legacy wireless environments. Multi-radio devices, such as the wireless device 20 of FIG. 3, may avoid performing time-consuming sequential media sensing (scanning) on each network to discover if wireless connectivity is possible at a given location. Especially for delay-sensitive applications such as voice-over-internet protocol (VoIP) over wireless, the client-based information system 100 enables the wireless device 20 to obtain the list of networks a priori, so that a seamless handover between multiple wireless networks may be achieved.

The queries made by the wireless device 20 to the local information server 50 may be made in a standard TLV format. Further, by using smart queries (and smart search algorithms on the information database 50), the overhead to the device 20 may be minimized, relative to legacy systems.

Using the standard format and smart queries provides a performance benefit to the wireless device 20, in some embodiments. For example, where the device is moving relatively quickly through the geographic region 60, there are some networks for which information is not desired. Thus, when the wireless device 20 is in an automobile or train, localized WiFi hotspots are not valuable, due to the limited coverage such hotspots may provide at that speed. Accessing the local information server 50 for the information elements 38 instead of the wireless networks individually reduces the possibility of false handovers.

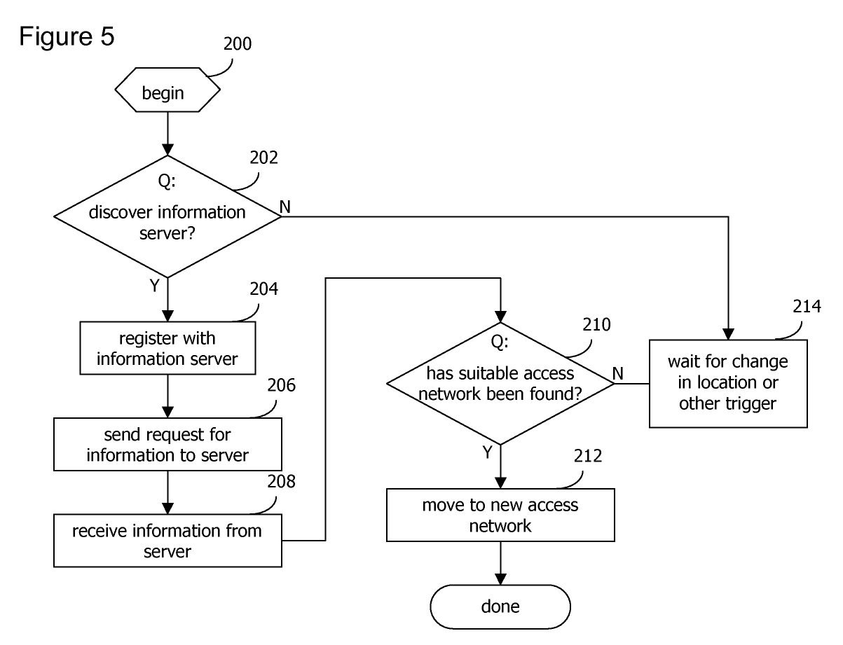

FIG. 5 is a flow diagram depicting a method 200 used by the client-based information system 100, according to some embodiments, to establish a connection with the remote information server 30, and, subsequently, with a desired wireless network within a geographic region 60. In contrast to the protocol 80 described in FIG. 4, in which connection to the remote server 30 may be avoided, FIG. 5 describes operations performed by the wireless device 20 in accessing the remote server 30.

The wireless device 20 attempts to discover the information server 30 (block 202). Where the information server 30 is unavailable, the wireless device 20 waits for a trigger, such as a change in location that may result in another remote information server 30 being available (block 214). (As an alternative, the wireless device 20 may operate in a “legacy mode”, in which the connection to a wireless network is achieved by each radio 46 scanning its associated network, etc.).

Where the remote information server 30 is found (the “yes” prong of block 202), the wireless device 20 registers with the information server 30 (block 204). The wireless device 20 also sends a request for information to the server 30, such as by submitting a MIH_get_information_request, as described in FIG. 4, above (block 206), and receives information back (e.g., MIH_get_information_response) from the server 30 (block 208). At this point, the wireless device 20 is provided with information elements 38 about available wireless networks in the geographic region 60. The information elements 38 may be downloaded to the local information server 50.

From the information elements 38 provided by the information server 30, the wireless network 20 determines whether a suitable access network has been found (block 210). If not, the wireless device 20 waits for a trigger, such as a change in location, to occur (block 214). Otherwise, where a suitable access network is found by the wireless device 20, the device moves to the new access network (block 212), such as by submitting a request to the relevant remote server 30 (e.g., MIH_get_information request).

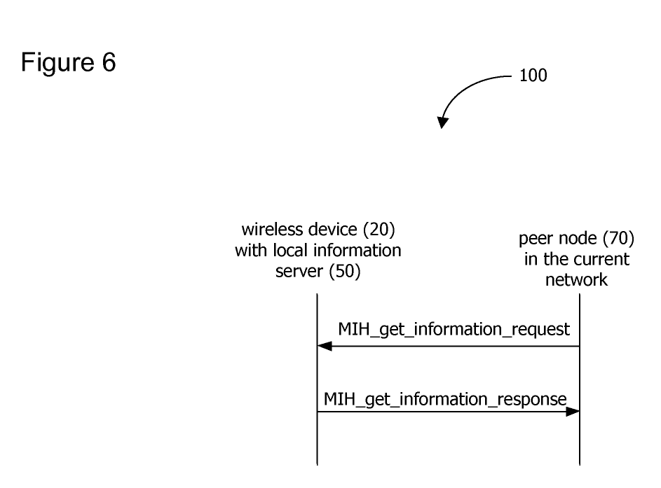

FIG. 6 is a flow diagram showing how one wireless device that does not have access to the local information server 50 (known as a peer node 70) may use a wireless device 20 that does have access to the local information server 50 to obtain the relevant information elements 38 for establishing a connection to one of the wireless networks. The wireless device 20 has downloaded the information elements 38 to its local storage 88. The peer node 70 submits a MIH_get_information_request to the wireless device 20. The wireless device 20 submits a MIH_get_information_response to the peer node 70, along with the information elements 38 that will enable the peer node 70 to subsequently connect to a desired wireless network.

The local information server 50 may be updated over time by the user of the wireless device 20. This enables the local information server 50 to be “customized” according to the uses, desires, and preferences of the user of the wireless device. The user of the wireless device 20 may update the local information server 50 with information pertinent to that user, such as information about wireless networks pertinent to the user. While the information elements 38 may be downloaded entirely from the remote server 30 to the local information server 50, there may be a protocol to obtain selective information elements. Or, there may be a protocol for synchronizing between the current data on the information server 50 and the remote server 30, such that only new information elements 38 are downloaded. System designers of ordinarily skill in the art recognize a number of implementations for downloading data from the remote server 30 to the local information server 50.

The client-based information system 100 is also advantage in terms of power savings for the wireless device 20. Some radios 46 on the wireless device 20 may be in a low-power state. Waking the radios to do media sensing may result in loss of power for the wireless device, particularly for small factor mobile devices. The client-based information system 100 allows the wireless device 20 to determine all wireless networks in a given area in a non-ambiguous manner and provides enhanced and efficient network discovery and selection options.

Various platforms in mobile and handheld technologies are beginning to have multiple radios. While roaming across various networks, users are likely to prefer experiencing a seamless handoff between these radios, where user connections are also preserved. The user of the wireless device 20 may also prefer to use the “best” wireless network, from the available choices in the wireless neighborhood 44, to connect to using the corresponding radio (where “best” may be based on a number of different criteria). The client-based information system 100 allows the wireless device 20 to optimally gather results of media sense for different radios 46 and to optimally discover and select various networks, in some embodiments.

The client-based information system 100 may become part of a future wireless standard, such as 802.21. This would allow for optimum roaming/handoff between 802.11 and 802.16 networks. Microsoft® may incorporate this functionality in their Operating Systems as part of components like WPS (Wireless Provisioning Service).

While the disclosure has been described with respect to a limited number of embodiments, those skilled in the art will appreciate numerous modifications and variations therefrom. It is intended that the appended claims cover all such modifications and variations as fall within the true spirit and scope of the disclosed subject matter.

What is claimed is:

1. A client-based information system accessible to a wireless device, the information system, comprising:
a plurality of wireless networks in a geographic region;
a wireless device in the geographic region, the wireless device comprising one or more radios, wherein each of the one or more radios is capable of scanning to detect the availability of one of the plurality of wireless networks;
a local information server accessible to a radio of the one or more radios, the local information server comprising a plurality of information elements downloaded from a remote information server, each information element comprising a characteristic of a wireless network of the one or more wireless networks;
wherein the radio retrieves the plurality of information elements from the local information server without having to scan any of the plurality of wireless networks.

2. The client-based information system of claim 1, wherein the plurality of information elements comprise information to facilitate network discovery and selection by the wireless device.

3. The client-based information system of claim 1, the plurality of information elements further comprising:
a list of available networks;
link layer information for the available networks; and
point of attachment information for the available networks.

4. The client-based information system of claim 1, wherein one of the plurality of information elements is selected from a group consisting of:
a list of available networks, link layer information, point of attachment information, link level information, security information, operator information, carrier policy, information a list of operators supporting a network, a roaming agreement between operators of a network, a neighbor report for a network, a property of a particular point of attachment for a network, security of a network, quality-of-service of a network, and supported data rates of a network.

5. The client-based information system of claim 1, wherein the plurality of wireless networks comprise at least a first wireless network and a second wireless network, the system further comprising:
a second radio, wherein the second radio is capable of detecting the second wireless network and the radio is capable of detecting the first wireless network;
wherein the radio identifies the availability of the second wireless network by retrieving the plurality of information elements from the local information server.

6. The client-based information system of claim 1, the wireless device further comprising storage to store the plurality of information elements.

7. The client-based information system of claim 1, the information server further comprising:
a wireless neighborhood map for the geographic region, the wireless neighborhood map indicating an availability of wireless networks within the geographic region.

8. The client-based information system of claim 7, further comprising:
a second wireless neighborhood map for a second geographic region, the second wireless neighborhood map indicating an availability of wireless networks within the second geographic region.

9. The client-based information system of claim 8, wherein the wireless device is not located within the second geographic region.

10. The client-based information system of claim 1, wherein the local information server is updated with additional information pertinent to a user of the wireless device.

11. The client-based information system of claim 10, wherein the radio retrieves the plurality of information elements by:
sending a get_information_request command to the local information server, wherein the command is transmitted using a media-independent handover protocol; and
receiving a get_information_response reply from the local information server, wherein the reply is transmitted using the media-independent handover protocol.

12. The client-based information system of claim 11, wherein the radio establishes a connection to the wireless network by:
sending a get_information_request command to the remote server; and
receiving a get_information_response reply from the remote server.

13. A method to identify wireless networks available within a geographic region, the method comprising:
discovering an information server by a radio of a wireless device, the information server comprising an information database having a plurality of information elements, the information elements comprising information enabling access to one or more wireless networks in the geographic region;
submitting an information request to the information server for the plurality of information elements;
receiving an information response from the information server, the information response including information elements; and
accessing a wireless network within the geographic region using the information elements without performing a scan of the wireless network by the radio.

14. The method of claim 13, accessing the wireless network further comprising:
sending a second information request to a remote server of the wireless network, wherein the second information request is based on the information elements.

15. The method of claim 14, further comprising:
receiving a second information response from the remote server of the wireless network.

16. The method of claim 13, further comprising:
storing the information elements in a storage of the wireless device.

17. The method of claim 16, further comprising:
receiving a third information request from a peer node to the wireless device, the peer node being unable to access the information server; and
sending a third information response by the wireless device to the peer node, the third information response including the information elements.
